(19) United States
(12) Patent Application Publication
(10) Pub. No.: US 2018/0303236 A1
(43) Pub. Date: Oct. 25, 2018

(54) SWING ARM HINGE ATTACHED TO GUARD PLATE

(71) Applicant: FORD MOTOR COMPANY, Dearborn, MI (US)

(72) Inventors: Mark THOMPSON, White Lake, MI (US); John NOONAN, Royal Oak, MI (US); Stephen Patrick DELY, Grosse Pte., MI (US); Mark GRIFFIN, Birmingham, MI (US); Robert VAUGHEN, Farmington Hills, MI (US)

(21) Appl. No.: 15/493,583

(22) Filed: Apr. 21, 2017

(51) Int. Cl. A47B 46/00; F16C 11/04; A47B 87/00; F16B 5/08; F16B 5/12; A47B 81/00

(52) U.S. Cl. CPC A47B 46/005; F16C 11/04; A47B 81/00; F16B 5/08; F16B 5/12; A47B 87/001

(57) ABSTRACT

A rack and a method of assembling the rack are disclosed that includes guard plates welded to right and left sides of a tubular frame. Each guard plate includes a fixed bushing. A locking bar pivots on pivot bushings provided on right and left swing arms. Right and left pins are assembled into one of the fixed and pivot bushings with a head of each pin contacting one pivot bushing, and a shaft of each pin being welded to the fixed bushing.

### TECHNICAL FIELD

This disclosure relates to a hinge for a swing arm of a rack used to retain parts during transport.

### BACKGROUND

Dunnage refers to containers or racks used to transport parts between and around manufacturing plants and assembly plants. Parts are transported by rail or truck and must be protected from damage during shipment and interplant transfers. Dunnage must be durable to protect the parts from damage.

Parts are loaded onto specialized racks having bars and spacers that securely hold the parts in place and prevent parts from contacting other parts during transit. Swing arms are moved between a locking position and a loading/unloading positions. Once the racks are fully loaded a swing arm may be used to lock the parts in place and prevent the parts from moving, even if a truck or train suddenly stops, starts or turns. Prior art swing arms are pivotally secured to the frame of the rack. The frame of the rack is formed by tubular members that are welded together to create an area within the rack for parts to be arranged.

Swing arms may include a counterweight to reduce the effort required to raise the bar into its locking position from a loading/unloading position. The pivot mechanism must be robust and able to withstand shifting of heavy loads without becoming disconnected or without breaking away from the hinge mechanism or the latch mechanism.

This disclosure is directed to solving the above problems and other problems as summarized below.

### SUMMARY

A dunnage rack is disclosed for transporting parts by rail or by common carrier and for transporting parts within manufacturing and assembly plants. Racks must be easy to load and unload and must be robust to withstand loads caused by movement of the rack during transportation.

According to one aspect of this disclosure, a swing arm locking bar is attached to a frame of a rack that is used to retain parts in the rack. The swing arm is moved out of the way when the rack is loaded and is moved into a locking position after the parts are placed in the rack. The swing arm is pivotally attached to a guard plate that is welded to a tubular frame. A locking bar is attached to a swing arm that includes a pivot bushing. A fixed bushing is welded to the guard plate and a hinge including a pin is assembled into the pivot bushing and fixed bushing. A head of the pin contacts the pivot bushing and the fixed bushing is secured to the pin with a rivet and a tack weld.

According to other aspects of this disclosure, the weld securing the fixed bushing to the pin may be formed adjacent an end of the pin opposite the head of the pin.

The guard plate may be welded to a lower/side cross member of the tubular frame, a front upright member of the tubular frame and an intermediate/side cross member of the tubular frame.

The fixed bushing may include a head portion that has a notch that is used to align an opening defined in a barrel portion of the fixed bushing with the front of the rack.

The pin may define a rivet receiving opening that is aligned with the opening in the barrel portion of the fixed bushing and the rivet may be inserted into the rivet receiving opening and the opening in the barrel portion of the fixed bushing.

The pivot bushing may include a head that is welded to the swing arm.

The rivet may include a rivet head and the rivet head and an adjacent portion of the fixed bushing barrel are marked after the rivet is installed to facilitate visual verification of the rivet installation operation.

According to another aspect of this disclosure, a rack apparatus is provided that includes guard plates welded to right and left sides of a tubular frame. Each guard plate includes a fixed bushing. A locking bar pivots on pivot bushings provided on right and left swing arms. Right and left pins are assembled into one of the fixed and pivot bushings with a head of each pin contacting one pivot bushing, and a shaft of each pin being welded to the fixed bushing.

The pins may be fixed relative to the guard plates and the swing arms are adapted to pivot about the pins on the pivot bushings.

The swing arms pivot the locking bar between a loading position and a locked position.

Rivets may be inserted into a pair of aligned first openings, with a first opening being defined by the fixed bushing and a second opening defined by the shaft of each pin that is aligned with the first openings.

The fixed bushings may be welded to the pins adjacent an end of each pin opposite the head of the pin.

According to another aspect of this disclosure, a method is disclosed for assembling a dunnage rack. The method comprises the steps of providing a tubular frame and welding a guard plate to right and left sides of the frame. A fixed bushing is then welded to each guard plate. A pivot bushing is then welded to right and left swing arms of a locking bar. A pin is then inserted into each pivot bushing and each pin is then welded to one of the fixed bushings.

The method may further comprise riveting the fixed bushing to a shaft of the pin to provide a redundant attachment mechanism for securing the fixed bushing to the pin.

The fixed bushing may be welded to the pin adjacent an end of the pin on the opposite side of the guard plate from the swing arm.

The above aspects of this disclosure and other aspects will be described below with reference to the attached drawings.

### BRIEF DESCRIPTION OF THE DRAWINGS

FIG. 1 is a perspective view of a parts rack made according to one embodiment of this disclosure.

FIG. 2 is an exploded perspective view of a hinge assembly, swing arm and guard plate made according to one embodiment of this disclosure.

FIG. 3 is a front elevation view of the hinge assembly connecting the guard plate to the swing arm according to one embodiment of this disclosure.

FIG. 4 is a side elevation view taken along line 4-4 in FIG. 3.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

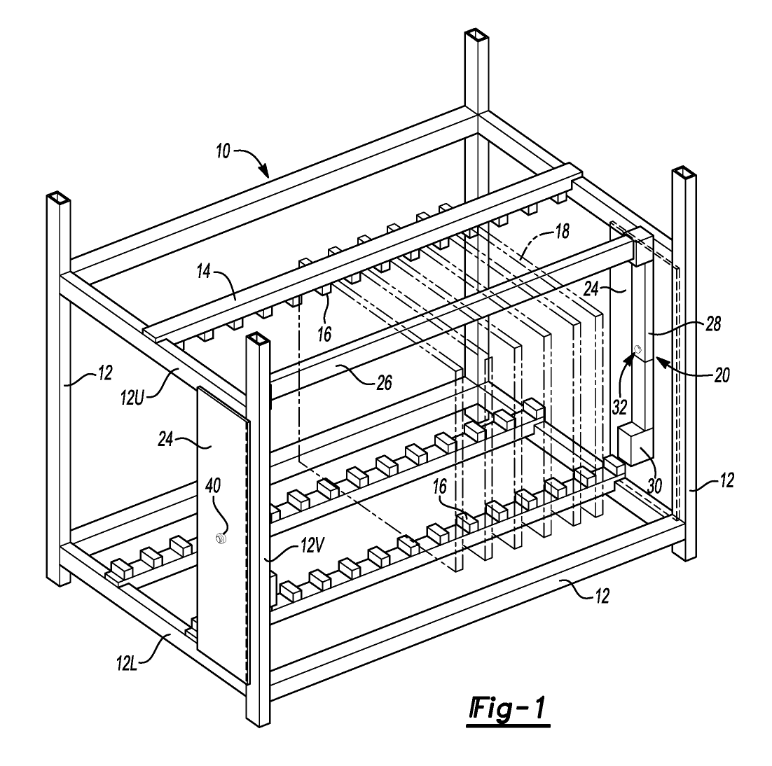

Referring to FIG. 1, a parts rack is generally indicated by reference numeral 10. The parts rack 10 may also be referred to as a dunnage rack. The parts rack 10 includes a tubular frame 12 that consists of vertical and horizontal tubes welded together that define a rectangularly shaped cube storage space. A plurality of dunnage bars 14 including spacers 16 are attached to the tubular frame 12 and are adapted to receive a plurality of parts 18 that are secured within the parts rack 10. The parts 18 are moved through fabrication and assembly plants on the racks 10 and are also transported between manufacturing and assembly locations by rail or truck. Parts rack 10 are subjected to impacts and shifting load and must be robustly constructed to avoid damage to parts 18 contained within the racks 10.

A swing arm assembly 20 is pivotally secured to the parts rack 10. The swing arm assembly 20 (as shown in FIG. 1) is in a raised or locking position in which the parts 18 are held securely on the dunnage bars 14. The swing arm assembly 20 may be pivoted to a lowered or loading/unloading position when parts 18 are loaded onto the dunnage bars 14 between the spacer 16 and when they are removed from the parts rack 10.

A guard plate 24 is attached to the frame 12. The guard plate 24 is provided to eliminate pinch points that may exist when the swing arm assembly is pivoted between the locking and loading/unloading positions. A locking bar 26 is provided on the swing arm assembly 20 that is locked to the tubular frame 12 to hold the parts 18 in the rack 10. The locking bar 26 is attached to a swing arm 28 portion of the swing arm assembly 20. A counterweight 30 is provided on the opposite end of the swing arm 28 from the locking bar 26. The swing arm assembly 20 is attached by a hinge assembly 32 to the guard plate 24.

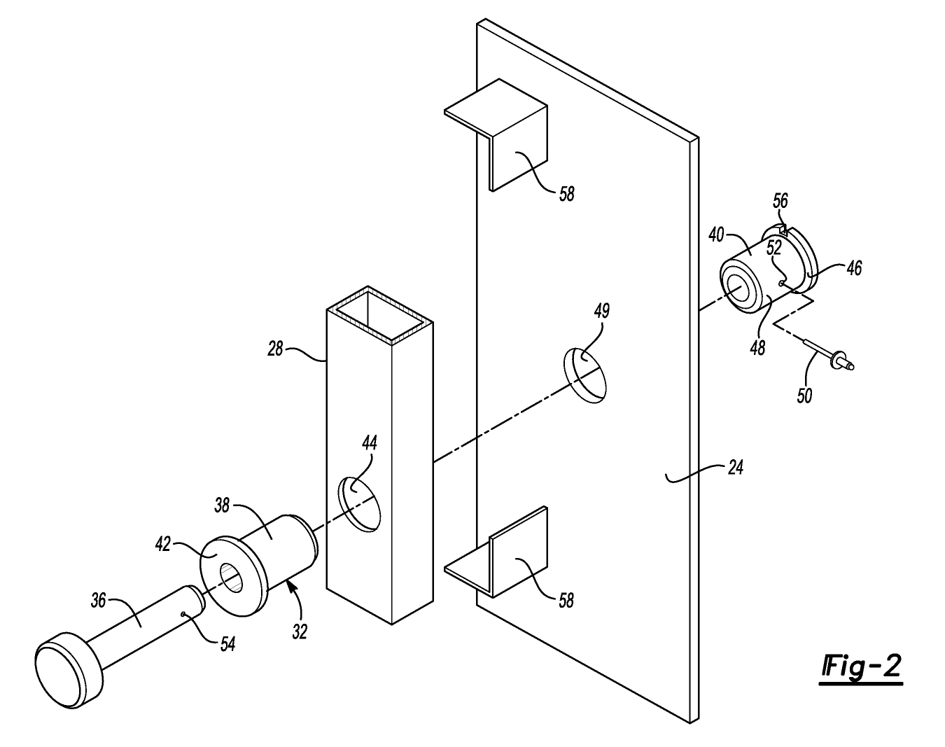

Referring to FIG. 2, the hinge assembly 32 is shown to include a pin 36 that is received in a pivot bushing 38. The pivot bushing 38 is inserted into the swing arm 28 to facilitate pivoting the swing arm 28 on the pin 36. A fixed bushing 40 is provided on the guard plate 24 and is adapted to receive the pin 36. Pin 36 is attached to the fixed bushing 40 in a fixed relationship.

A head 42 of the pivot bushing 38 is fixedly attached to the swing arm 28 with the pivot bushing 38 being received within an opening 44 in the swing arm 28. A head 46 of the fixed bushing 40 is fixedly secured to the guard plate 24. A barrel portion 48 of the fixed bushing 40 is inserted into and received within an opening 49. Opening 49 is provided in the guard plate 24. The head 46 of the fixed bushing 40 is attached to the guard plate 24 on the opposite side of the guard plate 24 from the swing arm assembly 20.

A rivet 50 is inserted into an opening 52 provided in the barrel portion 48 of the fixed bushing 40. Another opening 54 is provided in the pin 36. The rivet 50 is inserted into the opening 52 and opening 54. The rivet 50 is preferably a pop rivet that is used to secure the pin 36 within the fixed bushing 40. The pop rivet is permanently secured within the openings 52 and 54 and may only be removed if it is drilled to remove the rivet from the openings.

An alignment notch 56 is provided on the fixed bushing 40 to facilitate aligning the opening in the fixed bushing 40 with the front of the rack 10. When the alignment notch 56 is in the twelve o'clock position, the opening 54 is oriented to face the front of the rack 10. Two stops 58 are shown attached to the guard plate 24. The stops 58 are used to stop the pivoting motion of the swing arm assembly as it is moved between the locked position and the loading/unloading position.

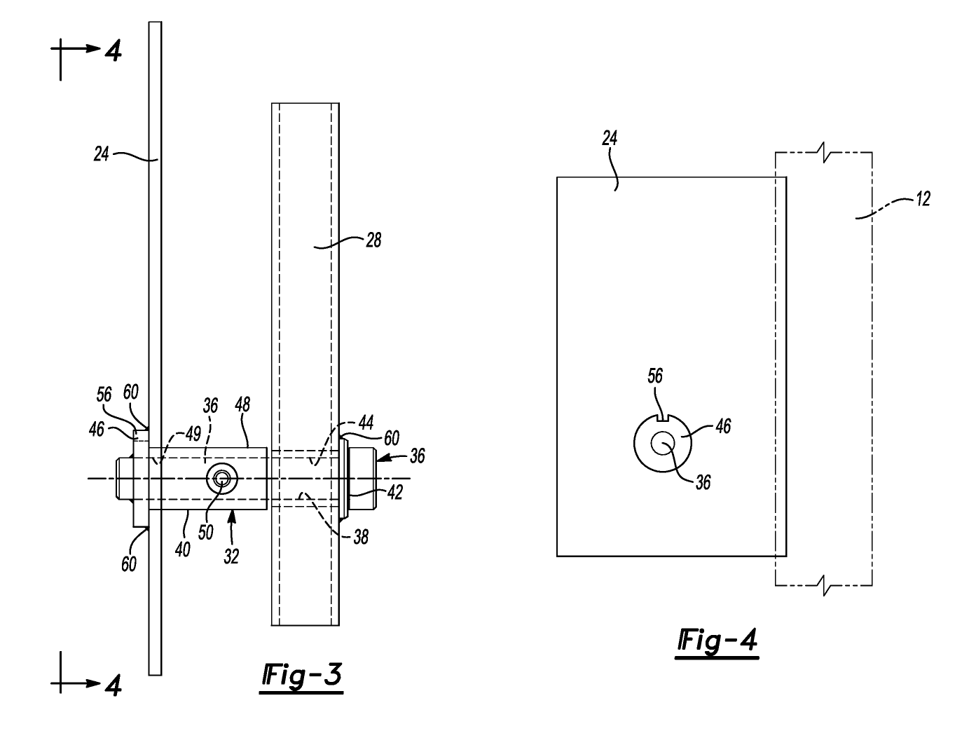

Referring to FIG. 3, the hinge assembly 32 is shown that attaches the guard plate 24 to the swing arm 28. The hinge assembly 32 includes a pin 36 that is inserted through the pivot bushing 38 and received in the fixed bushing 40. The head 42 of the pivot bushing 38 is welded to the inner side of the swing arm 28. The head 42 is welded to the side of the swing arm 28 by welds 60.

The head 46 of the fixed bushing 40 is welded at welds 60 to the outer side of the guard plate 24. The barrel portion 48 of the fixed bushing 40 is received in the opening 49 formed in the guard plate 24. The head 46 is welded to the outer side of the guard plate 24.

The pop rivet 50 is installed and permanently fixed within the opening 52 in the barrel portion of the fixed bushing 40 and in the opening 54 provided in the pin 36. The head of the pop rivet 50 and surrounding area on the fixed bushing 40 may be painted to provide a way to verify proper installation of the rivet 50 in the fixed bushing 40.

The pin 36 is also welded at welds 60 to the head 46 of the fixed bushing 40. The welds 60 securing the pin 36 to the fixed bushing 40 and the pop rivet 50 provide a redundant double attachment arrangement for securing the pin 36 within the fixed bushing 40. Both the welds 60 and pin 50 resist separation of the pin 36 from the fixed bushing 40 to provide a robust hinge assembly that secures the swing arm 28 to the guard plate 24.

Referring to FIG. 4, the guard plate 24 is shown with the pin 36 being received within the fixed bushing 40. The guard plate 24 is secured to the tubular frame 12 by welds. The orientation of the alignment notch 56 is shown to be at the twelve o'clock or in the top portion of the head 46 of the fixed bushing 40.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

1. A rack apparatus comprising:
a pair of guard plates welded to and extending between upper and lower horizontal tubes and a vertical tube of a tubular frame;
a locking bar attached to a swing arm having a pair of pivot bushings;
a fixed bushing welded to each of the guard plates; and
a pin assembled into each of the pivot bushings and each of the fixed bushings with a head of each of the pins contacting one of the pivot bushings, wherein the fixed bushings are secured to one of the pins with a rivet and by a weld.

2. The rack apparatus of claim 1 wherein each of the welds securing the fixed bushing to the pin is formed adjacent an opposite end of the pin from the head of the pin.

3. (canceled)

4. The rack apparatus of claim 1 wherein the fixed bushings each includes a head portion that has a notch that is used to align an opening defined in a barrel portion of the fixed bushing with a front side of the rack.

5. The rack apparatus of claim 4 wherein each of the pins define a rivet receiving opening that is aligned with the opening in the barrel portion of the fixed bushing, wherein the rivet is inserted into the rivet receiving opening and the opening in the barrel portion of the fixed bushing.

6. The rack apparatus of claim 1 wherein each of the pivot bushings include a head that is welded to the swing arm.

7. (canceled)

8. A rack apparatus comprising:
right and left guard plates each being welded to opposite sides of a tubular frame, the guard plates spanning between at least two horizontal tubes and a vertical tube;
a fixed bushing attached to each guard plate, the fixed bushing being spaced from the horizontal tubes and the vertical tube;
right and left swing arms each include a pivot bushing for pivoting a locking bar; and
right and left pins are assembled into one of the fixed and pivot bushings with a head of each pin contacting one pivot bushing, and a shaft of each pin being welded to the fixed bushing.

9. The rack apparatus of claim 8 wherein the pins are fixed relative to the guard plates and the swing arms pivot about the pins on the pivot bushings.

10. The rack apparatus of claim 8 wherein the swing arms pivot the locking bar between a loading position and a locked position.

11. The rack apparatus of claim 8 further comprising:
a rivet inserted into a pair of aligned first openings defined by the fixed bushing and a second opening defined by the shaft of each pin that is aligned with the first openings.

12. The rack apparatus of claim 8 wherein each of the fixed bushings is welded to one of the pins adjacent an end of the pin opposite the head of the pin.

13. A method of assembling a dunnage rack comprising:
providing a tubular frame;
welding a guard plate to right and left sides of the frame;
welding a fixed bushing to each guard plate;
welding a pivot bushing to right and left swing arms of a locking bar;
inserting a pin into each pivot bushing; and
welding each pin to one of the fixed bushings.

14. The method of claim 13 further comprising:
riveting the fixed bushing to a shaft of the pin to provide a redundant attachment mechanism for securing the fixed bushing to the pin.

15. The method of claim 13 wherein the fixed bushing is welded to the pin adjacent an end of the pin on the opposite side of the guard plate from the swing arm.

16. A rack apparatus comprising:
a frame;
first and second guard plates each being attached to two spaced horizontal tubes and a vertical tube on opposite sides of the frame;
a fixed bushing attached to each guard plate at a location spaced from the horizontal tubes and the vertical tube;
a locking bar including swing arms including a pair of pivot bushings; and
pins assembling each pivot bushing to one of the fixed bushings.
